(19) United States
(12) Patent Application Publication
(10) Pub. No.: US 2026/0166658 A1
(43) Pub. Date: Jun. 18, 2026

(54) WELDING MONITORING DEVICE

(71) Applicant: Panasonic Intellectual Property Management Co., Ltd., Osaka (JP)

(72) Inventors: IZURU NAKAI, Osaka (JP); YOSHIRO KITAMURA, Osaka (JP); AKIRA KUMAGAWA, Osaka (JP)

(21) Appl. No.: 19/534,554

(22) Filed: Feb. 9, 2026

Related U.S. Application Data
(63) Continuation of application No. PCT/JP2024/038029, filed on Oct. 24, 2024.

(30) Foreign Application Priority Data
Jan. 10, 2024 (JP) 2024-002013

(51) Int. Cl. B23K 31/12; B23K 26/03; B23K 26/21

(52) U.S. Cl. CPC B23K 31/12; B23K 26/032; B23K 26/21

(57) ABSTRACT

In observation of molten portion (270) during welding, two optical paths for reflected light (205), visible light (206), and thermal radiation light (207) are prepared, and in order to cause the light to enter the optical paths, the light is separated by wavelength-separating mirror (211), and then combined by wavelength-combining mirror (221). Reflected light (205), visible light (206), and thermal radiation light (207) are coaxially combined by the wavelength-combining mirror, and then enter end face (252) of optical fiber (13) connected to spectrometer (40) connected to determination device (50) that determines a welding state. Collimator (290) changes, based on a core diameter of the end face of the optical fiber, at least a beam diameter of reflected light to a beam diameter different from beam diameters of the visible light and the thermal radiation light.

### TECHNICAL FIELD

The present disclosure relates to a welding monitoring device that determines a welding state in laser welding machining, and particularly relates to a structure of a laser machining device in the device.

### BACKGROUND ART

A conventional unit for determining a welding state in laser welding determines a welding state and occurrence of a welding defect by observing reflected light obtained by reflecting laser light used for laser welding on a machined portion, and plasma light and thermal radiation light emitted by heating a portion irradiated with the laser light (see, for example, PTL 1). FIG. 9 is a diagram illustrating a configuration of a conventional laser machining device described in PTL 1.

In FIG. 9, laser oscillator 101 generates laser light, and the laser light is transmitted to lens barrel 103 through laser transmission fiber 102, converted into parallel laser light 106 by collimating lens 104, reflected by first mirror 107, and condensed on molten portion 27 of workpiece 70 through condenser lens 105. At a machining point of molten portion 27, a part of laser light 106 emitted returns in an irradiation direction as reflected light. Further, when workpiece 70 is molten, plasma light and thermal radiation light are generated, and return to condenser lens 105 similarly to the reflected light. A part of the reflected light, the plasma light, and the thermal radiation light passes through first mirror 107, is reflected by second mirror 108, enters optical fiber 113 by condenser lens 111, is sent to spectrometer 140, is converted from light into a signal, and is sent to a determination device (not illustrated).

### CITATION LIST

### Patent Literature

PTL 1: International Publication No. 2022/181359

### SUMMARY OF THE INVENTION

A configuration of a laser machining device in the conventional determination unit is based on an optical system of a fixed lens barrel, and when the laser machining device is applied to an optical system including a galvanometer scanner, there is a concern about the following problem.

FIG. 10 is a diagram illustrating an outline when a conventional lens barrel is combined with a galvanometer scanner unit. Description of a portion overlapping with FIG. 9 will be omitted. In FIG. 10, an optical system present between workpiece 70 and condenser lens 105 on an optical path of the conventional lens barrel illustrated in FIG. 9 is galvanometer scanner unit 1240, and any position on workpiece 260 can be irradiated with laser light 106 by causing galvanometer mirror 1241 to oscillate. In a case where a scan position is the central position of scan lens 242, reflected light, plasma light, and thermal radiation light emitted from molten portion 261 at the center of the scan position enter optical fiber 113 and are sent to spectrometer 140, similarly to the conventional lens barrel. On the other hand, in a case where the scan position is an end position of scan lens 1242, since scan lens 1242 is designed in accordance with the wavelength of laser light 106, the plasma light and the thermal radiation light emitted from molten portion 262 at the end of the scan position cause chromatic aberration at the time of light transmission, and are at positions shifted relative to the position of the reflected light when entering optical fiber 113. Therefore, it is necessary to relatively increase the size of a measurement region as compared with the case of using the fixed lens barrel.

In recent years, for the purpose of stabilizing a molten portion for welding, a laser oscillator including a core part and a ring part has been used to preheat the periphery of the molten portion. In a case where such a laser oscillator is used while the measurement region is large, the surface of the workpiece is not molten with a preheating part of the ring part, and thus the effect of reflected light is large, and information about the reflected light from the molten portion by the core part is buried. Therefore, there is a problem that the SN ratio of the reflected light from the molten portion is degraded and that the accuracy of determining the welding state decreases, and there is a challenge to reduce the effect of the reflected light from the ring part not having information reflecting the state of the molten portion.

An object of the present disclosure is to provide a welding monitoring device capable of stably performing determination without degrading an SN ratio of a reflected light signal in an optical system including a laser scanning unit.

The fixed lens barrel indicates an optical system that does not include a movable optical component such as a galvanometer mirror in an optical path for laser light.

A welding monitoring device according to one aspect of the present disclosure that determines a welding state based on thermal radiation light, visible light, and reflected light generated at a molten portion formed on a surface of a workpiece by irradiating the workpiece with laser light from a laser oscillator, the welding monitoring device including: a wavelength-separating mirror that separates at least one light out of the thermal radiation light, the visible light, and the reflected light from remaining light; a first lens barrel through which the at least one light passes; a second lens barrel through which the remaining light passes; a collimator that is disposed in the first lens barrel and changes a beam diameter of the at least one light to a beam diameter different from each beam diameter of the remaining light; and a wavelength-combining mirror that coaxially combines the at least one light that has been separated by the wavelength-separating mirror and passed through the first lens barrel and the collimator, and the remaining light that has passed through the second lens barrel.

With this configuration, even when laser light having a preheating effect, such as a ring part of a ring mode laser, is used in a laser scanning unit, such as a galvanometer scanner unit, for example, reflected light from the ring part is prevented from entering an optical fiber, and the SN ratio of the reflected light is improved, so that information about a molten portion can be easily obtained, and the accuracy of the determination can be improved.

As described above, according to the welding monitoring device according to the aspect of the present disclosure, by appropriately changing the beam diameter of the at least one light to a beam diameter different from each beam diameter of the remaining light, it is possible to stably determine the welding state without degrading the SN ratio of the reflected light signal in an optical system including the laser scanning unit. Therefore, for example, it is possible to reduce or remove the effect of the reflected light from the ring part of the ring mode laser, for example, which has a high reflectance and does not include information about the molten portion because, for example, metal is not molten. As a result, information only or mainly about the reflected light from the molten portion can be obtained, and as compared with the reflected light, it is possible to keep a measurement region of weak visible light and thermal radiation light in small amounts relatively large, and it is possible to prevent a decrease in the accuracy of determining the welding state.

### BRIEF DESCRIPTION OF THE DRAWINGS

FIG. 1 is a diagram illustrating an overview of a determination system according to a first exemplary embodiment of the present disclosure.

FIG. 2 is a diagram illustrating a configuration of a laser machining device according to the first exemplary embodiment of the present disclosure.

FIG. 3 is a diagram illustrating a configuration of a spectrometer in the determination system.

FIG. 4 is a block diagram illustrating a configuration of a determination device in the determination system.

FIG. 5 is a diagram illustrating a relationship between a measurement range and an optical system.

FIG. 6 is a schematic diagram illustrating condensed spots of light on an entrance end face of an optical fiber. Part (a) is a diagram of a conventional laser machining device described in PTL 1. Part (b) is a diagram of a conventional laser machining device combined with a galvanometer scanner unit. Part (c) is a diagram a case where a ring laser oscillator is combined with (b). Part (d) is a diagram a case in a first exemplary embodiment of the present disclosure.

FIG. 7 is a diagram illustrating signals of an optical sensor according to the first exemplary embodiment of the present disclosure.

FIG. 8 is a flowchart illustrating a determination process in the determination device.

FIG. 9 is a diagram illustrating a configuration of a conventional laser machining device described in PTL 1.

FIG. 10 is a diagram illustrating an outline when a conventional lens barrel is combined with a galvanometer scanner unit.

### DESCRIPTION OF EMBODIMENT

Hereinafter, exemplary embodiments will be described in detail with reference to the drawings as appropriate. However, unnecessarily detailed descriptions may be omitted. For example, detailed descriptions of already well-known matters or repeated descriptions of substantially the same configuration may be omitted. This is to avoid an unnecessarily redundant description below and to facilitate understanding of a person skilled in the art. Note that, the attached drawings and the following description are presented by the inventors of the present disclosure so that those skilled in the art can fully understand the present disclosure, and are not intended to limit the subject matter as described in the claims.

### First Exemplary Embodiment

### 1. Configuration

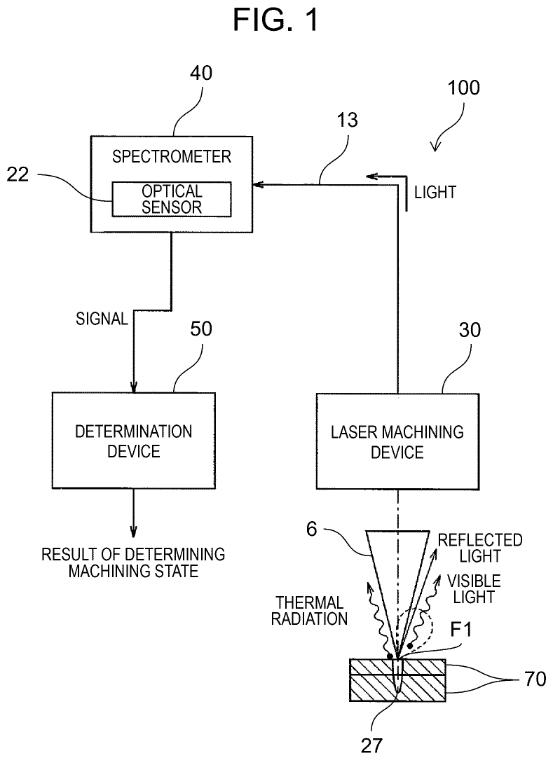

A determination system according to a first exemplary embodiment will be described with reference to FIG. 1. FIG. 1 is a diagram illustrating an outline of determination system 100 that is an example of a welding monitoring device according to the first exemplary embodiment.

### 1-1. Outline of System

Determination system 100 includes, as an example, laser machining device 30 that performs laser machining for lap welding, spectrometer 40 for detecting a component of light, and determination device 50, irradiates workpiece 70 with laser light 6 from laser oscillator 1, and determines a welding state based on thermal radiation light 207, visible light 206, and reflected light 205 generated at molten portion 27 formed on a surface of workpiece 70.

Laser machining device 30, spectrometer 40, and determination device 50 are examples of a laser machining device, a spectrometer, and a determination device according to the above-described aspect of the present disclosure, respectively.

Laser machining device 30 includes at least a laser scanning unit, wavelength-separating mirror 211, first lens barrel 210, second lens barrel 220, collimator 290 (212, 213), and wavelength-combining mirror 221.

Galvanometer scanner unit 240 is an example of the laser scanning unit, and causes galvanometer mirror 241 to oscillate to irradiate workpiece 70 with laser light 6 while scanning workpiece 70.

Wavelength-separating mirror 211 separates at least one light out of thermal radiation light 207, visible light 206, and reflected light 205, for example, reflected light 205, from remaining light, for example, thermal radiation light 207 and visible light 206.

First lens barrel 210 allows reflected light 205, which is an example of the at least one light, to pass therethrough.

Second lens barrel 220 allows thermal radiation light 207 and visible light 206, which are examples of the remaining light, to pass therethrough.

Collimator 290 changes a beam diameter of reflected light 205 in first lens barrel 210 to a beam diameter different from beam diameters of thermal radiation light 207 and visible light 206.

Wavelength-combining mirror 221 coaxially combines reflected light 205 that has been separated by wavelength-separating mirror 211 and passed through first lens barrel 210 and collimator 290, and thermal radiation light 207 and visible light 206 that have passed through second lens barrel 220.

Reflected light 205, thermal radiation light 207, and visible light 206 are coaxially combined by wavelength-combining mirror 221, and then enter end face 252 of optical fiber 13 connected to spectrometer 40 connected to determination device 50 that determines the welding state.

Collimator 290 changes the beam diameter of reflected light 205 to a beam diameter different from each beam diameter of the remaining light based on a core diameter of end face 252 of optical fiber 13. For example, in the case of a ring mode laser as an example of laser oscillator 1, the beam diameter of reflected light 205 is changed such that ring part 205b of reflected light 205 is greater than the core diameter of end face 252 of optical fiber 13 and that core part 205a of reflected light 205 is less than the core diameter of end face 252 of optical fiber 13.

These configurations will be described in more detail below.

Workpiece 70 to be subjected to lap welding is made of, for example, metal, and when workpiece 70 is irradiated with laser light 6, thermal radiation light 207 in the near-infrared region due to an increase in temperature, and visible light 206, that is, light emission or plasma light emission, which is specific to metal and is mainly a visible light component, are generated.

In addition, a part of laser light 6 that does not contribute to machining is reflected as return light, that is, reflected light 205. As described above, when workpiece 70 is irradiated with laser light 6 from laser machining device 30, thermal radiation light 207, visible light 206, and reflected light 205 are generated at molten portion 27 that is an example of a welded portion formed on workpiece 70.

The generated light is condensed in laser machining device 30 and is transmitted to spectrometer 40 through optical fiber 13 connecting laser machining device 30 to spectrometer 40.

The light transmitted to spectrometer 40 is dispersed into components of thermal radiation light 207, visible light 206, and reflected light 205, and detected by optical sensor 22 of spectrometer 40, and converted into signals.

When receiving the signals from spectrometer 40, determination device 50 determines a welding state such as abnormal combustion due to a deviation in a focal position or/and contamination at focal position F1 of laser light 6, and outputs a result of the determination.

When workpiece 70 is irradiated with laser light 6, the position where a spot diameter of laser light 6 is minimized in the vicinity of a surface of workpiece 70 is set as a reference value of “0”, and the deviation in focal position F1 is determined based on a numerical value including farness or closeness (“−” or “+”) in the irradiation direction with respect to the reference. In the abnormal combustion, since combustion gas is generated due to contamination or the like, a change in the intensity of reflected light 205 due to a variation of a molten pool of molten portion 27, an increase in visible light 206 and thermal radiation light 207 due to the combustion, or the like is observed. The abnormal combustion is determined based on occurrence of a rapid change in an optical sensor signal.

Note that, in this case, lap welding is described as an example, but the present disclosure may be applied to other welding methods such as butt welding.

### 1-2. Configuration of Laser Machining Device

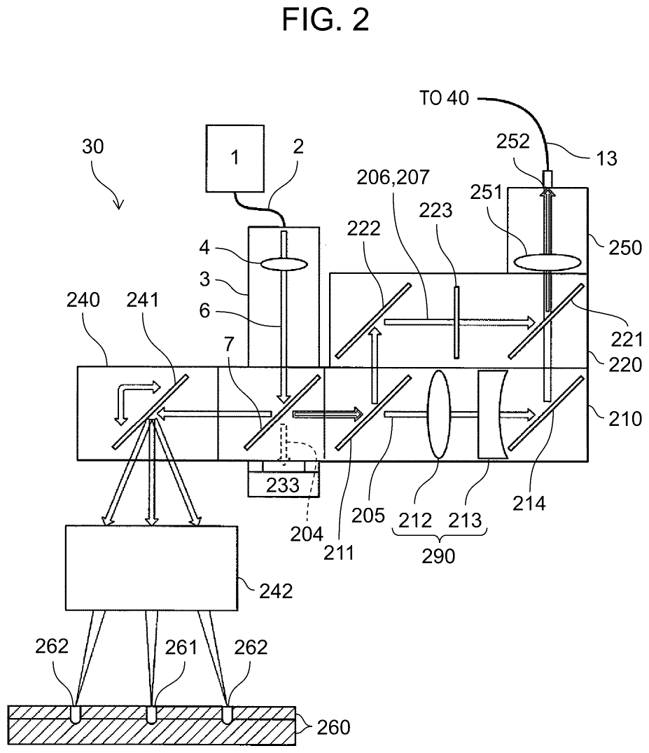

FIG. 2 is a diagram illustrating a configuration of laser machining device 30 according to the first exemplary embodiment. As an example, laser machining device 30 includes laser oscillator 1, laser transmission fiber 2, lens barrel 3, collimating lens 4, galvanometer scanner unit 240, galvanometer mirror 241, scan lens 242, first mirror 7, first lens barrel 210, wavelength-separating mirror 211, lens 212, lens 213, mirror 214, second lens barrel 220, wavelength-combining mirror 221, mirror 222, notch filter 223, incident lens barrel 250, and lens 251.

Laser oscillator 1 supplies light for generating pulsed laser light 6 having a wavelength of, for example, about 1070 nanometers (nm). The light supplied from laser oscillator 1 is transmitted to lens barrel 3 through laser transmission fiber 2, passes through collimating lens 4 for obtaining a parallel beam in lens barrel 3, forms laser light 6, and travels straight in lens barrel 3. In this case, configurations of laser oscillator 1 and laser transmission fiber 2 may be a single core or a configuration of an oscillator having a double core or triple core profile with a ring part.

Laser light 6 is reflected by first mirror 7 except for a part that passes through first mirror 7, is reflected by galvanometer mirror 241, and is condensed on workpiece 260 by scan lens 242. In this case, by changing a rotation angle of galvanometer mirror 241, irradiation can be performed while changing the position of laser light 6 on workpiece 260 (corresponding to workpiece 70 in FIG. 1). As a result, laser machining for lap welding of workpiece 260 is performed.

Note that, the wavelength of laser light 6 is not particularly limited to 1070 nm and it is preferable to use a wavelength with a high material absorption rate.

When workpiece 260 is irradiated with laser light 6, thermal radiation light 207 from workpiece 260, visible light 206 by plasma emission, and reflected light 205 of laser light 6 are generated at molten portion 261. These light components pass through scan lens 242, and are reflected by galvanometer mirror 241, and pass through first mirror 7 on one end side of first lens barrel 210. Thermal radiation light 207 and visible light 206 are reflected by wavelength-separating mirror 211 and travel to one end side of second lens barrel 220. Reflected light 205 passes through wavelength-separating mirror 211 and travels to the other end side of first lens barrel 210. As an example, first lens barrel 210 and second lens barrel 220 are arranged such that optical axes of first lens barrel 210 and second lens barrel 220 are parallel to each other.

In first lens barrel 210, lens 212 and lens 213 constitute reduction collimator 290, and reflected light 205 passes through reduction collimator 290 to reduce the beam diameter, is reflected by mirror 214 on the other end side of first lens barrel 210, and enters second lens barrel 220 on the other end side of second lens barrel 220.

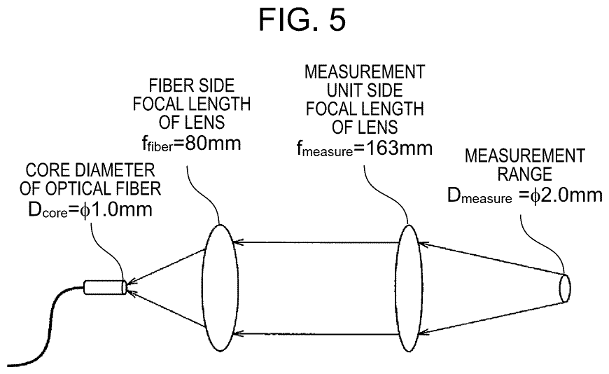

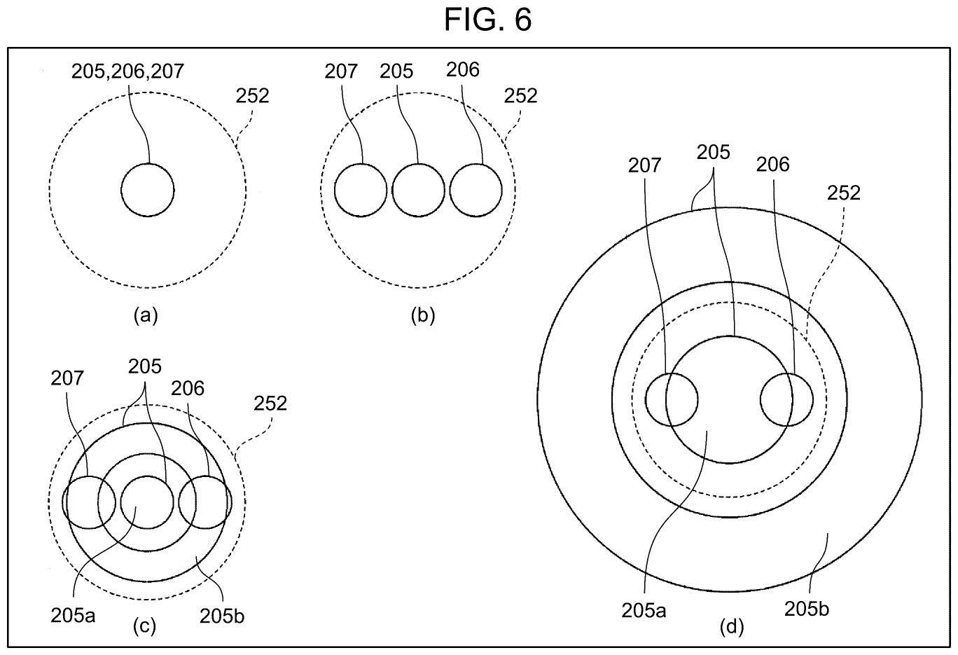

Note that, as will be described in detail with reference to FIGS. 5 and 6 described later, the magnification of reduction collimator 290 indicates a measurement range of reflected light 205, and it is possible to suppress the effect of light serving as noise by changing the collimator magnification. In the case of an optical fiber including a ring part and a core part, the outer diameter of the core part serving as a signal source is about a fraction to 1/10 of the outer diameter of the ring part mainly serving as a noise source, and accordingly, the collimator magnification in this case is in a range from 0.95 times to 0.1 times inclusive. Here, the diameter of reflected light 205 imaged on end face 252 of the optical fiber by reduction collimator 290 is proportional to the reciprocal of the collimator magnification. That is, in a case where the collimator magnification is in the range from 0.95 times to 0.1 times inclusive, the diameter of reflected light 205 imaged is 1.05 times to 10 times larger. That is, in a case where the ratio of the outer diameter of the core part to the outer diameter of the ring part is 1/10, the imaging range of reflected light 205 by the core part becomes substantially equal to the diameter of end face 252 of the optical fiber by setting the collimator magnification to 0.1 times, and reflected light 205 by the ring part can be prevented from entering optical fiber 13. The same calculation can be performed in a case where the ratio of the outer diameters is one in several.

In second lens barrel 220, thermal radiation light 207 and visible light 206 are reflected by mirror 222 in a direction parallel to reflected light 205 in first lens barrel 210, pass through notch filter 223, are reflected by wavelength-combining mirror 221, and travel to incident lens barrel 250.

Notch filter 223 is set to block the wavelength of reflected light 205.

In wavelength-combining mirror 221, reflected light 205 that has entered from first lens barrel 210 side is transmitted and guided to incident lens barrel 250. In this case, positions and angles of mirror 214 and mirror 222 are adjusted such that reflected light 205, thermal radiation light 207, and visible light 206 directed from second lens barrel 220 to incident lens barrel 250 are coaxial.

Note that, as a system of reduction collimator 290, in FIG. 2, a Galilean system with a combination of convex and concave lenses which are lens 212 and lens 213 is used, but a Kepler system with a combination of convex and convex lenses may be used.

In incident lens barrel 250, reflected light 205, visible light 206, and thermal radiation light 207 are condensed on end face 252 of the fiber by lens 251 and transmitted to spectrometer 40 through optical fiber 13. Since reflected light 205, visible light 206, and thermal radiation light 207 are superimposed, only one optical fiber 13, which is similar to the conventional optical fiber, is required to transmit light to spectrometer 40 so that retrofitting can be performed on a portion other than the optical system of the laser machining device.

Photodetector 233 or a camera may detect laser light 204 that is a part of laser light 6 that has passed through first mirror 7.

### 1-3. Configuration of Spectrometer

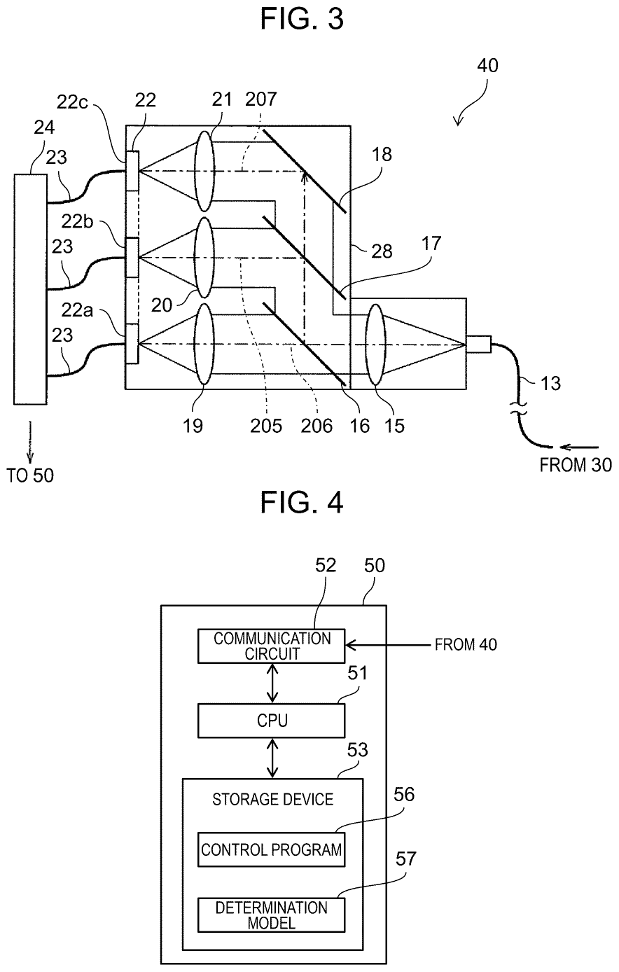

FIG. 3 is a diagram illustrating a configuration of spectrometer 40 according to the first exemplary embodiment. Spectrometer 40 includes, in housing 28, collimating lens 15, third mirror 16, fourth mirror 17, fifth mirror 18, condenser lenses 19, 20, and 21, optical sensor 22 (22a, 22b, 22c), transmission cable 23, and controller 24.

Housing 28 prevents other external light from entering from outside spectrometer 40 and leakage of light from inside spectrometer 40.

Collimating lens 15 changes the light transmitted from laser machining device 30 through optical fiber 13 into parallel light again.

For example, third mirror 16 transmits visible light 206 having, for example, a wavelength in a range from 400 nm to 700 nm inclusive, and reflects other components. Fourth mirror 17 reflects reflected light 205 of laser light 6 having, for example, a wavelength of about 1070 nm, and transmits other components. Fifth mirror 18 reflects thermal radiation light 207 having, for example, a wavelength in a range from 1300 nm to 1550 nm inclusive.

The light having passed through collimating lens 15 is dispersed by third mirror 16, fourth mirror 17, and fifth mirror 18 into components of visible light 206, reflected light 205, and thermal radiation light 207, and the dispersed components are condensed by condenser lenses 19 to 21. A bandpass filter for visible light 206, reflected light 205, and thermal radiation light 207 may be arranged in an optical path after third mirror 16, fourth mirror 17, and fifth mirror 18, and capable of selecting a wavelength of light to be passed.

Optical sensor 22 includes, for example, optical sensors 22a, 22b, 22c each having high sensitivity for a wavelength that differs among optical sensors 22a, 22b, 22c. Optical sensors 22a, 22b, and 22c detect components of visible light 206, reflected light 205, and thermal radiation light 207 condensed by condenser lenses 19 to 21, respectively, and each of optical sensors 22a, 22b, and 22c generates an electrical signal corresponding to the intensity of the detected light. Note that, optical sensor 22 may be a single optical sensor capable of detecting the intensity of the light for each wavelength.

Each of the electrical signals generated by optical sensor 22 is transmitted to controller 24 through transmission cable 23.

Controller 24 is a hardware controller. Controller 24 includes a CPU and a communication circuit, and transmits the electrical signals received from optical sensor 22 to determination device 50. Controller 24 includes, for example, an A/D converter, and converts an analog electrical signal into a digital signal (also simply referred to as “signal”). Note that, a sampling period of the conversion into the digital signal is preferably, for example, less than or equal to 1/100 of a time for performing output control of laser light 6 from the viewpoint of securing a sufficient number of samples to capture a feature of a machining process and a trend of a local value of a physical quantity in the determination of the welding state.

### 1-4. Configuration of Determination Device

FIG. 4 is a block diagram illustrating a configuration of determination device 50 according to the first exemplary embodiment. Determination device 50 is, for example, an information processing device such as a computer. Determination device 50 includes CPU 51 that performs arithmetic processing, communication circuit 52 for communication with other devices, and storage device 53 that stores data and a computer program.

CPU 51 is an example of an arithmetic circuit of determination device 50 according to the first exemplary embodiment. CPU 51 implements predetermined functions including training and execution of determination model 57 by executing control program 56 stored in storage device 53. Determination device 50 implements a function as determination device according to the first exemplary embodiment by CPU 51 executing control program 56. The arithmetic circuit configured as CPU 51 in the first exemplary embodiment may be implemented by various processors such as an MPU and a GPU, or may be configured by one or a plurality of processors.

Communication circuit 52 is a communication circuit that performs communication in accordance with a standard such as IEEE 802.11, 4G, or 5G. Communication circuit 52 may perform wired communication in accordance with a standard such as Ethernet (registered trademark). Communication circuit 52 is connectable to a communication network such as the Internet. In addition, determination device 50 may directly communicate with another device via communication circuit 52, or may communicate via an access point. Note that, communication circuit 52 may be configured to be able to communicate with other devices without a communication network. For example, communication circuit 52 may include connection terminals such as a USB (registered trademark) terminal and an HDMI (registered trademark) terminal.

Storage device 53 is a storage medium that stores a computer program and data necessary for implementing a function of determination system 100, and stores control program 56 executed by CPU 51 and data of various kinds. After construction of determination model 57, storage device 53 stores determination model 57.

Storage device 53 is configured as, for example, a magnetic storage device such as a hard disk drive (HDD), an optical storage device such as an optical disk drive, or a semiconductor storage device such as an SSD. Storage device 53 may include a temporary storage element configured by a RAM such as a DRAM or an SRAM, and may function as an internal memory of CPU 51.

### 2. Operation

In determination system 100 configured as described above, for example, as illustrated in FIG. 1, laser machining device 30 branches components of reflected light 205, visible light 206, and thermal radiation light 207 generated at molten portion 27 by irradiating workpiece 70 with laser light 6, and causes the branched components to pass through first lens barrel 210 or second lens barrel 220, so that a measurement region can be limited, and the light obtained from molten portion 27 can be selected and sent to spectrometer 40. In spectrometer 40, optical sensor 22 detects the components of thermal radiation light 207, visible light 206, and reflected light 205 transmitted from laser machining device 30 through optical fiber 13. Spectrometer 40 transmits a signal corresponding to the intensity of each of the detected components to determination device 50.

Operations of laser machining device 30 and determination device 50 in determination system 100 will be described below.

### 2-1. Measurement Region Limiting Process

A measurement region limiting process of limiting the measurement region of reflected light 205 and suppressing a decrease in information about molten portion 27 in laser machining device 30 will be described below with reference to FIGS. 5 and 6.

FIG. 5 is a diagram illustrating a relationship between a measurement range and the optical system in laser machining device 30 according to the first exemplary embodiment. The relationship between the core diameter of optical fiber 13 and the measurement range in which the light emitted from molten portion 27 can be condensed on and enter the core of optical fiber 13 is expressed as follows, for example, where the core diameter of optical fiber 13 is D_{core}=1.0 mm, the measurement range is Dₘₑₐₛᵤᵣₑ, the focal length of lens 251 on optical fiber 13 side is f_{fiber}=80 mm, and the focal length of lens 242 on the molten portion side is fₘₑₐₛᵤᵣₑ=163 mm. Each of the above-described numerical values is a value in the first exemplary embodiment.

Dₘₑₐₛᵤᵣₑ=D_{core}×fₘₑₐₛᵤᵣₑ÷f_{fiber}

=Φ1.0 mm×163 mm÷80 mm

=Φ2.0 mm
That is, in the first exemplary embodiment, light generated in a range of Φ2.0 mm as the measurement range is measured. In FIG. 2, the lens on the molten portion side corresponds to scan lens 242, and the lens on the optical fiber side corresponds to lens 251.

Next, how the collimator magnification of lens 212 and lens 213 in first lens barrel 210 affects the measurement range will be described. In the first exemplary embodiment, in a case where the collimator magnification is 0.5 times, the following relationship is obtained.

Dₘₑₐₛᵤᵣₑ=D_{core}×fₘₑₐₛᵤᵣₑ÷f_{fiber}×collimator magnification

=Φ1.0 mm×163 mm÷80 mm×0.5 times

=Φ1.0 mm
In other words, in a case where the size of molten portion 27 does not change, for example, in a case where molten portion 27 is set to Φ2.0 mm and the collimator magnification is set to 0.5, the light transmitted in the range of Φ2.0 mm can be limited to be radiated on end face 252 of an entrance end of optical fiber 13, and enter only a region of Φ1.0 mm of the core diameter of optical fiber 13.

FIG. 6 is a schematic diagram illustrating condensed spots of light on end face 252 of the entrance end of optical fiber 13.

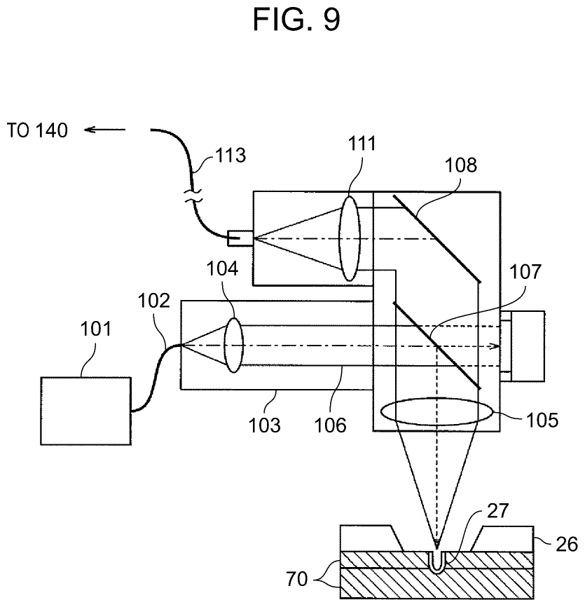

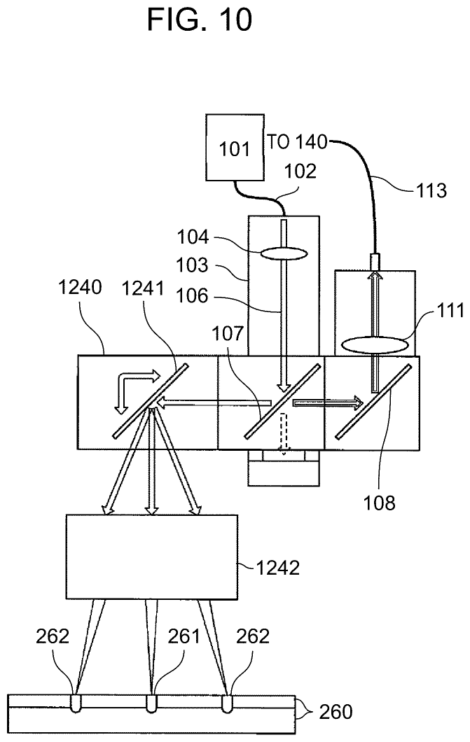

Part (a) of FIG. 6 illustrates the positions, on the entrance end face of the optical fiber, of condensed spots of reflected light 205, visible light 206, and thermal radiation light 207 generated from the optical system of the conventional laser machining device illustrated in FIG. 9 and the molten portion at the scanning central position illustrated in FIG. 2. It is illustrated that reflected light 205, visible light 206, and thermal radiation light 207 are condensed at substantially the same position with respect to the core diameter of entrance end face 252 of the optical fiber and that all of the light enters.

Part (b) of FIG. 6 illustrates the positions, on entrance end face 252 of the optical fiber, of condensed spots of reflected light 205, visible light 206, and thermal radiation light 207 generated from molten portion 261 at the scanning central position illustrated in FIG. 2. The condensed spots of visible light 206 and thermal radiation light 207 move to positions opposite to each other relative to reflected light 205 on entrance end face 252 of the optical fiber due to chromatic aberration when the light passes through scan lens 242 designed based on the wavelength of laser light 6. Therefore, when scan lens 242 is used, the focal length of scan lens 242 is set to 163 mm and the focal length of lens 251 is set to 80 mm such that the measurement range is Φ2.0 mm in order to efficiently acquire visible light 206 and thermal radiation light 207.

Part (c) of FIG. 6 is an example in which a ring mode laser that has been widely used for stabilizing welding in recent years is used for laser oscillator 1. In this case, reflected light 205 follows the ring mode shape of laser oscillator 1 as it is. Therefore, workpiece 70 is not molten with reflected light 252b of a ring part used for preheating, and reflected light 252b of the ring part has a higher intensity than reflected light 252a of a core part corresponding to molten portion 27. Therefore, the accuracy of information about a welding state of molten portion 27 decreases.

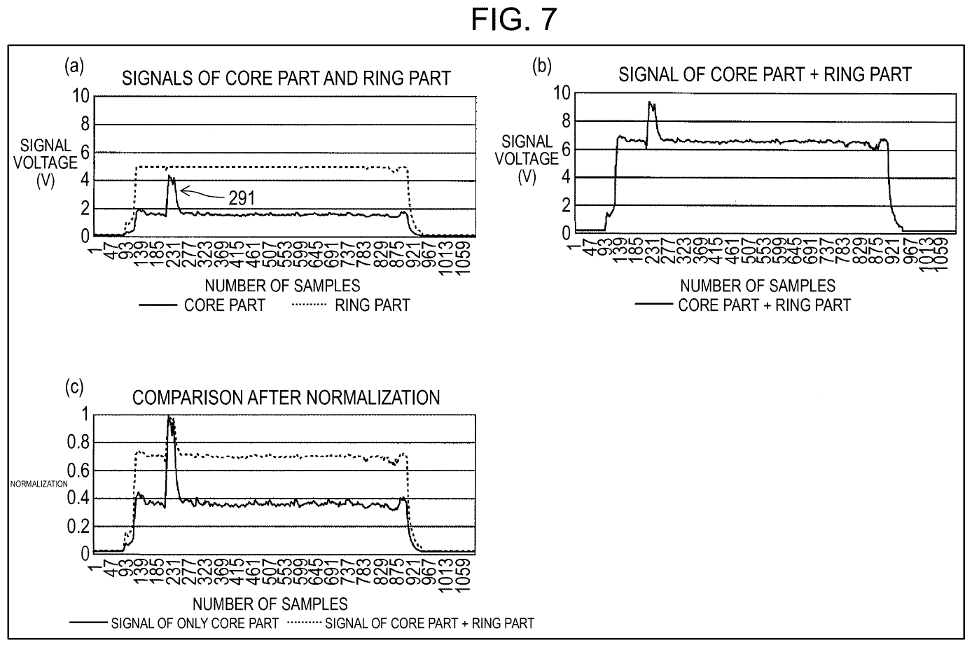

FIG. 7 is a diagram illustrating signals of optical sensor 22 in the first exemplary embodiment of the present disclosure. Part (a) of FIG. 7 illustrates a signal from core part 205a of reflected light 205 and a signal from ring part 205b of reflected light 205, pointed signal 291 indicating an abnormality of molten portion 27 is recorded in the signal of core part 205a, and the signal voltage of ring part 205b is higher than the signal voltage of core part 205a. In the laser machining device having the conventional configuration, a signal voltage waveform as illustrated in part (b) of FIG. 7 is obtained, and an SN ratio of a pointed voltage change indicating the abnormality is not good.

Part (d) of FIG. 6 illustrates the positions of condensed spots, on entrance end face 252 of the optical fiber, of reflected light 205, visible light 206, and thermal radiation light 207 by the ring mode laser oscillator when the collimator magnification of collimator 290 by lens 212 and lens 213 of first lens barrel 210 is set to 0.3 times. In this case, since ring part 205b of reflected light 205 is greater than the core diameter of entrance end face 252 of the optical fiber, ring part 205b does not enter optical fiber 13, and information about the molten portion obtained with only core part 252a of reflected light 205 is obtained, so that the SN ratio is improved as compared with the state illustrated in part (c) of FIG. 6.

Part (c) of FIG. 7 is obtained by normalizing and comparing a change in the signal voltage between a case where information about only core part 252a is obtained and a case where the signals of the core part and the ring part are mixed. It can be seen that a noise level for pointed signal 291 indicating the abnormality is clearly improved.

In this way, in order to clearly improve the noise level for pointed signal 291 indicating the abnormality, the inner diameter of ring part 205b of reflected light 205 may be set to be greater than the core diameter of entrance end face 252 of the optical fiber such that ring part 205b of reflected light 205 does not enter entrance end face 252 of the optical fiber. However, the present disclosure is not limited thereto, and in order to be able to practically recognize that the noise level has been improved, it is preferable to prevent a part or all of ring part 205b of reflected light 205 from entering entrance end face 252 of the optical fiber. In other words, ring part 205b of reflected light 205 may be arranged with respect to entrance end face 252 of the optical fiber such that the average signal intensity of ring part 205b of reflected light 205 is less than or equal to 20% of the average signal intensity of core part 205a of reflected light 205 in cases including a case where the noise level can be clearly improved and a case where it can be practically recognized that the noise level can be improved.

With the configuration illustrated in part (d) of FIG. 6, it is possible to remove light that becomes noise and comes from the periphery of molten portion 27, and it is possible to determine the welding state even when galvanometer scanner unit 240 and the ring mode laser are used.

In the first exemplary embodiment, reflected light 205 has the wavelength of about 1070 nm of laser light 6, visible light 206 has the wavelength in the range from 400 nm to 700 nm inclusive, and thermal radiation light 207 has the wavelength in the range from 1300 nm to 1550 nm inclusive. In particular, since the wavelength of reflected light 205 depends on the laser to be used, a laser oscillator suitable for machining may be selected.

### 2-2. Determination Process

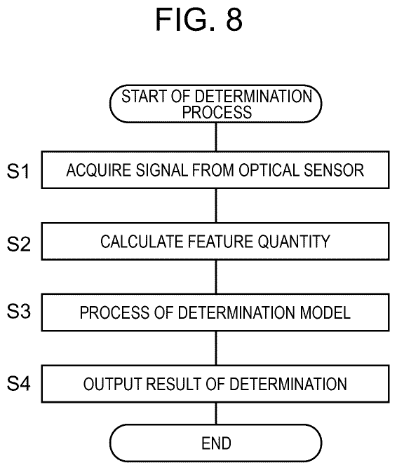

Hereinafter, a determination process of determining, as the welding state, a deviation in focal position F1 in determination device 50 will be described with reference to FIG. 8.

FIG. 8 is a flowchart illustrating the determination process in determination device 50 according to the first exemplary embodiment. Each process in the flowchart is executed by, for example, CPU 51 of determination device 50. The flowchart starts by, for example, a user of determination system 100 or the like inputting a predetermined operation for starting the determination process from an input device connected via communication circuit 52.

First, CPU 51 acquires, via communication circuit 52, a signal corresponding to each of the components of the thermal radiation light, the visible light, and the reflected light detected by optical sensor 22 of spectrometer 40 (step S1).

Next, CPU 51 calculates a feature quantity to be input to determination model 57 from the obtained signal (step S2).

In particular, the thermal radiation light and the visible light easily reflect a change in a molten state of a material of workpiece 260, and the deviation in focal position F1 can be accurately determined by using a slope of the signal waveform as the feature quantity for these components. The feature quantity is not limited to the slope, and can also be used for detection of a welding abnormality such as occurrence of sputtering by comparing the average signal intensity at the time of measurement with the average signal intensity at the time of normal time measured in advance and defining the ratio as an amount of fluctuation in the signal intensity and using the ratio as the feature quantity.

After the feature quantity is calculated (step S2), CPU 51 performs a process (step S3) of inputting the feature quantity to determination model 57 and determining the deviation in focal position F1. In the present exemplary embodiment, in the process of the determination model (step S3), CPU 51 determines, as the deviation in focal position F1, a numerical value indicating a relative position of focal position F1 to a reference position.

CPU 51 outputs the result of determining the deviation in focal position F1 by the process of the determination model (step S3) via communication circuit 52 (step S4). The determination result can be received and displayed by, for example, an external information processing device or a display device. In addition, determination device 50 may include a display (for example, a display) capable of communicating with CPU 51 and display the determination result on the display.

Then, CPU 51 ends the flowchart in FIG. 8. The flowchart in FIG. 8 is repetitively executed, for example, whenever welding machining is performed for each workpiece 260.

According to the above-described determination process, determination device 50 according to the first exemplary embodiment acquires the signal generated by optical sensor 22 of spectrometer 40 (step S1), calculates the feature quantity from the signal (step S2), and determines the deviation in focal position F1 by determination model 57 based on the feature quantity (step S3). As a result, determination device 50 can determine in detail the deviation in focal position F1 of laser light 6 as the welding state in the laser machining for the lap welding.

### 3. Effects and Others

As described above, in the first exemplary embodiment, the welding monitoring device is provided which determines the welding state in laser machining enabling introduction of galvanometer scanner unit 240 for lap welding and butt welding by the laser machining device and application of laser oscillator 1 having a preheating effect, such as a ring laser. In the present device, the optical system of laser machining device 30 includes lens barrels 210, 220 of two systems, and reflected light 205, visible light 206, and thermal radiation light 207 are set in measurement regions suitable for the light (in other words, a part or all of ring part 205b of reflected light 205 is set not to enter entrance end face 252 of the optical fiber), so that it is possible to remove or suppress the effect of reflected light 205 from ring part 205b having high reflectance because the metal is not molten. As a result, it is possible to obtain only or mainly information about the reflected light from molten portion 27. In addition, it is possible to keep the measurement region of the plasma light of visible light 206 and thermal radiation light 207 relatively large, and it is possible to prevent the SN ratio of a measurement signal even with a weak light amount from being lowered as compared with reflected light 205. As a result, the SN ratio of the light transmitted to spectrometer 40 is improved, and the effect of improving the accuracy of the result of determining the welding state is obtained.

An appropriate combination of any exemplary embodiments or modifications among the various exemplary embodiments or modifications described above enables achieving the effects of each of the exemplary embodiments or modifications. In addition, combinations of the exemplary embodiments, combinations of the examples, or combinations of the exemplary embodiments and the examples can be used, and combinations of features in different exemplary embodiments or examples can also be used.

### (Supplementary Note)

The above description of the exemplary embodiments discloses the following techniques.

(Technique 1) A welding monitoring device that determines a welding state based on thermal radiation light, visible light, and reflected light generated at a molten portion formed on a surface of a workpiece by irradiating the workpiece with laser light from a laser oscillator, the welding monitoring device including:
a wavelength-separating mirror that separates at least one light out of the thermal radiation light, the visible light, and the reflected light from remaining light;
a first lens barrel through which the at least one light passes;
a second lens barrel through which the remaining light passes;
a collimator that is disposed in the first lens barrel and changes a beam diameter of the at least one light to a beam diameter different from each beam diameter of the remaining light; and
a wavelength-combining mirror that coaxially combines the at least one light that has been separated by the wavelength-separating mirror and passed through the first lens barrel and the collimator, and the remaining light that has passed through the second lens barrel.

(Technique 2) The welding monitoring device according to technique 1, further including a galvanometer scanner unit that irradiates the workpiece with the laser light while scanning the workpiece, wherein
the laser oscillator is a ring mode laser,
the reflected light of the ring mode laser includes a core part and a ring part,
the at least one light is the reflected light,
the at least one light and the remaining light are coaxially combined by the wavelength-combining mirror, and then enter an end face of an optical fiber connected to a spectrometer connected to a determination device that determines the welding state, and
the beam diameter of the at least one light is changed to cause the ring part of the reflected light to be greater than a core diameter of the end face of the optical fiber and cause the core part of the reflected light to be less than the core diameter of the end face of the optical fiber (in other words, the ring part of the reflected light is arranged with respect to the end face of the optical fiber such that the average signal intensity of the ring part of the reflected light is less than or equal to 20% of the average signal intensity of the core part of the reflected light).

(Technique 3) The welding monitoring device according to technique 1 or 2, wherein the at least one light includes the reflected light, and the remaining light includes the thermal radiation light and the visible light.

(Technique 4) The welding monitoring device according to any one of techniques 1 to 3, wherein the visible light has a wavelength range from 400 nm to 700 nm inclusive, the thermal radiation light has a wavelength in a range from 1300 nm to 1550 nm inclusive, and the reflected light has a wavelength equal to an oscillation wavelength of the laser oscillator to be used.

(Technique 5) The welding monitoring device according to any one of techniques 1 to 4, wherein the at least one light includes the reflected light, the remaining light includes the thermal radiation light and the visible light, and the wavelength-separating mirror reflects the wavelength of the visible light and the wavelength of the thermal radiation light and transmits the wavelength of the reflected light.

(Technique 6) The welding monitoring device according to any one of techniques 1 to 5, wherein the at least one light includes the reflected light, the remaining light includes the thermal radiation light and the visible light, and the wavelength-combining mirror coaxially combines the at least one light and the remaining light while reflecting the wavelength of the visible light and the wavelength of the thermal radiation light and transmitting the wavelength of the reflected light.

(Technique 7) The welding monitoring device according to any one of techniques 1 to 6, wherein the at least one light includes the reflected light, the remaining light includes the thermal radiation light and the visible light, and an optical path for the at least one light that has been separated by the wavelength-separating mirror and passed through the first lens barrel and the collimator, and an optical path for the remaining light that has been separated by the wavelength-separating mirror and passed through the second lens barrel are disposed.

(Technique 8) The welding monitoring device according to any one of techniques 1 to 7, wherein the collimator is a reduction collimator in which a magnification of the collimator is in a range from 0.95 times to 0.1 times inclusive.

A conventional system for determining a welding state in laser welding is configured based on an optical system of a fixed lens barrel, and when the system is applied to an optical system including a galvanometer scanner unit, a problem arises. In particular, at the time of scanning at the end position of a scan lens, chromatic aberration occurs, and the position of reflected light deviates. Furthermore, when a molten portion is stabilized using a laser oscillator, the effect of the reflected light increases, the SN ratio of a reflected light signal decreases, and the accuracy of determining the welding state decreases. Each of the above-described techniques solves these problems. That is, by appropriately changing the beam diameter of the at least one light to a beam diameter different from each beam diameter of the remaining light by each of the configurations, it is possible to stably perform determination without a decrease in the SN ratio of the reflected light signal in the optical system including the laser scanning unit. Therefore, for example, it is possible to reduce or remove the effect of the reflected light from the ring part of the ring mode laser, for example, which has a high reflectance and does not include information about the molten portion because, for example, metal is not molten. As a result, information only or mainly about the reflected light from the molten portion can be obtained, and as compared with the reflected light, it is possible to keep a measurement region of weak visible light and thermal radiation light in small amounts relatively large, and it is possible to prevent a decrease in the accuracy of determining the welding state.

### INDUSTRIAL APPLICABILITY

The welding monitoring device according to the above-described aspect of the present disclosure has an effect of preventing a decrease in an SN ratio of a measurement signal at the time of introduction of a laser oscillator having a preheating effect, such as a galvanometer scanner unit and a ring laser, for example, and can also be used as a determination monitor for determining a welding state of laser welding in manufacturing of a battery or an electronic device or the like.

### REFERENCE MARKS IN THE DRAWINGS

1 laser oscillator
2 laser transmission fiber
3 lens barrel
4 collimating lens
5,11 condenser lens
6 laser light
7 first mirror
8 second mirror
13 optical fiber
15 collimating lens
16 third mirror
17 fourth mirror
18 fifth mirror
19, 20, 21 condenser lens
22 optical sensor
23 transmission cable
24 controller
26 holding jig
27 molten portion
30 laser machining device
40 spectrometer
50 determination device
51 CPU
52 communication circuit
53 storage device
56 control program
57 determination model
70 workpiece
F1 focal position
D1 training data
100 determination system
201 laser oscillator
202 optical fiber
203 laser light
204 laser light that has passed
205 reflected light
205a core part of reflected light
205b ring part of reflected light
206 visible light
207 thermal radiation light
210 first lens barrel
211 wavelength-separating mirror
212 lens
213 lens
214 mirror
220 second lens barrel
221 wavelength-combining mirror
222 mirror
223 notch filter
233 photodetector
240 galvanometer scanner unit
241 galvanometer mirror
242 scan lens
250 incident lens barrel
251 lens
252 end face of fiber
260 workpiece
261 molten portion at center of scan position
262 molten portion at end of scan position
290 reduction collimator
291 pointed signal

1. A welding monitoring device that determines a welding state based on thermal radiation light, visible light, and reflected light generated at a molten portion formed on a surface of a workpiece by irradiating the workpiece with laser light from a laser oscillator, the welding monitoring device comprising:
a wavelength-separating mirror that separates at least one light out of the thermal radiation light, the visible light, and the reflected light from remaining light;
a first lens barrel through which the at least one light passes;
a second lens barrel through which the remaining light passes;
a collimator that is disposed in the first lens barrel and changes a beam diameter of the at least one light to a beam diameter different from each beam diameter of the remaining light; and
a wavelength-combining mirror that coaxially combines the at least one light that has been separated by the wavelength-separating mirror and passed through the first lens barrel and the collimator, and the remaining light that has passed through the second lens barrel.

2. The welding monitoring device according to claim 1, further comprising a galvanometer scanner unit that irradiates the workpiece with the laser light while scanning the workpiece, wherein
the laser oscillator is a ring mode laser,
the reflected light of the ring mode laser includes a core part and a ring part, the at least one light is the reflected light,
the at least one light and the remaining light are coaxially combined by the wavelength-combining mirror, and then enter an end face of an optical fiber connected to a spectrometer connected to a determination device that determines the welding state, and
the collimator changes the beam diameter of the at least one light to cause the ring part of the reflected light to be greater than a core diameter of the end face of the optical fiber and cause the core part of the reflected light to be less than the core diameter of the end face of the optical fiber.

3. The welding monitoring device according to claim 1, wherein the at least one light includes the reflected light, and the remaining light includes the thermal radiation light and the visible light.

4. The welding monitoring device according to claim 1, wherein the visible light has a wavelength range from 400 nm to 700 nm inclusive, the thermal radiation light has a wavelength in a range from 1300 nm to 1550 nm inclusive, and the reflected light has a wavelength equal to an oscillation wavelength of the laser oscillator to be used.

5. The welding monitoring device according to claim 4, wherein
the at least one light includes the reflected light,
the remaining light includes the thermal radiation light and the visible light, and
the wavelength-separating mirror reflects the wavelength of the visible light and the wavelength of the thermal radiation light and transmits the wavelength of the reflected light.

6. The welding monitoring device according to claim 4, wherein
the at least one light includes the reflected light,
the remaining light includes the thermal radiation light and the visible light, and
the wavelength-combining mirror coaxially combines the at least one light and the remaining light while reflecting the wavelength of the visible light and the wavelength of the thermal radiation light and transmitting the wavelength of the reflected light.

7. The welding monitoring device according to claim 1, wherein
the at least one light includes the reflected light,
the remaining light includes the thermal radiation light and the visible light, and
an optical path for the at least one light that has been separated by the wavelength-separating mirror and passed through the first lens barrel and the collimator, and an optical path for the remaining light that has been separated by the wavelength-separating mirror and passed through the second lens barrel are disposed.

8. The welding monitoring device according to claim 1, wherein the collimator is a reduction collimator in which a magnification of the collimator is in a range from 0.95 times to 0.1 times inclusive.
